(19) United States
(12) Patent Application Publication
(10) Pub. No.: US 2017/0357208 A1
(43) Pub. Date: Dec. 14, 2017

(54) DEVELOPING APPARATUS, PROCESS CARTRIDGE, AND IMAGE FORMING APPARATUS

(71) Applicant: CANON KABUSHIKI KAISHA, Tokyo (JP)

(72) Inventors: Naoki Matsumaru, Suntou-gun (JP); Daisuke Makiguchi, Izunokuni-shi (JP); Go Torii, Mishima-shi (JP)

(21) Appl. No.: 15/613,322

(22) Filed: Jun. 5, 2017

(30) Foreign Application Priority Data
Jun. 14, 2016 (JP) 2016-118005

(51) Int. Cl. G03G 21/18; G03G 15/08; G03G 15/01

(52) U.S. Cl. CPC G03G 21/18; G03G 15/0131; G03G 15/0891; G03G 15/0884

(57) ABSTRACT

An injection inlet for injecting elastomer into a gap between frames and a seal member, a storage portion in which the elastomer flowing out of the injection inlet is stored, and a protruding portion that protrudes toward a conveyance path of a recording medium to which a developer image is transferred, are provided in the frames, and the protruding portion protrudes toward the conveyance path further than the storage portion exposed to the conveyance path.

### BACKGROUND OF THE INVENTION

### Field of the Invention

The present invention relates to a developing apparatus that develops an electrostatic latent image formed on a photosensitive drum, a process cartridge that forms a developer image on the photosensitive drum and is detachably attached to an apparatus main body of an image forming apparatus, and the image forming apparatus that forms an image on a recording medium by using a developer.

### Description of the Related Art

Conventionally, in an image forming apparatus that uses electrophotographic techniques, a photosensitive drum charged by a charging roller is exposed by an exposure apparatus, and an electrostatic latent image is thereby formed on the photosensitive drum. The electrostatic latent image formed on the photosensitive drum is developed as a toner image by a developing apparatus, and the toner image on the photosensitive drum is transferred to a sheet such as a paper sheet. Subsequently, the toner image transferred to the sheet is fixed to the sheet by being heated and pressurized by a fixing apparatus.

Herein, in recent years, the charging roller, the photosensitive drum, the developing apparatus and the like are integrated as a process cartridge in the image forming apparatus. In addition, the process cartridge is detachably attached to the apparatus main body of the image forming apparatus. With this, by replacing the process cartridge, it is possible to perform, for example, replacement of process means such as the photosensitive drum and addition of toner. According to the process cartridge system described above, a user can perform the maintenance of the image forming apparatus, and hence it is possible to easily perform the maintenance of the image forming apparatus.

Herein, the frame of the developing apparatus in the process cartridge is conventionally formed by coupling a first frame and a second frame. In addition, by coupling the first frame and the second frame, a toner storage portion in which toner is stored, a developing chamber in which a developing roller is disposed, and an opening for conveying the toner from the toner storage portion to the developing chamber are formed in the developing apparatus. Further, conventionally, a seal member is provided in a gap between the developing roller and the frame in the vicinity of each of both end portions in the direction of the rotation center axis of the developing roller such that the toner does not leak from the gap between the developing roller and the frame.

In addition, conventionally, due to the displacement of the position of the seal member relative to the frame that is caused when the developing apparatus is assembled and the tolerance of the seal member, a gap has been formed between the seal member and the frame. To cope with this, in a technique disclosed in Japanese Patent Application Laid-open No. 2007-025345, in order to seal the gap between the seal member and the frame, elastomer is injected into the gap between the seal member and the frame. Specifically, an injection inlet for injecting liquid elastomer is provided in the frame, and the elastomer is poured into the gap between the seal member and the frame by injecting the elastomer into the injection inlet.

In the case of this configuration, it is proposed to adopt a configuration in which a fence for storing the elastomer spilling out of the injection inlet is provided (Japanese Patent Application Laid-open No. 2007-025345). The elastomer having spilled out of the injection inlet is stored in the fence provided around the injection inlet. With this, the injected elastomer is prevented from jutting out from the contour of the frame.

In recent years, the size of the image forming apparatus has been reduced. In order to reduce the size of the image forming apparatus, it is conceivable to adopt a configuration in which the fence for storing the elastomer is exposed to the path of the sheet conveyed in the image forming apparatus. However, when the elastomer or the fence for storing the elastomer is exposed to the path of the sheet, in the case where the sheet is curled, there is a possibility that the sheet comes into contact with the elastomer or the fence and jamming (paper jamming) is thereby caused.

### SUMMARY OF THE INVENTION

In order to achieve the above object, a developing apparatus as the present invention is a developing apparatus forming a developer image with a developer including a developer bearing member that carries the developer, a frame in which the developer bearing member is provided, a seal member that seals a gap between the developer bearing member and the frame such that the developer does not leak from the gap between the developer bearing member and the frame, and a sealing portion that seals a gap between the frame and the seal member such that the developer does not leak from the gap between the frame and the seal member, wherein the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and the protruding portion protrudes toward the conveyance path further than the storage portion exposed to the conveyance path.

In addition, in order to achieve the above object, a process cartridge as the present invention is a process cartridge detachably attached to an apparatus main body of an image forming apparatus, the process cartridge including an image bearing member on which a developer image is formed, a developer bearing member that carries a developer and develops the image bearing member, a frame in which the developer bearing member is provided, a seal member that seals a gap between the developer bearing member and the frame such that the developer does not leak from the gap between the developer bearing member and the frame, and a sealing portion that seals a gap between the frame and the seal member such that the developer does not leak from the gap between the frame and the seal member, wherein the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and the protruding portion protrudes toward the conveyance path further than the storage portion exposed to the conveyance path.

Further, in order to achieve the above object, an image forming apparatus as the present invention is an image forming apparatus including an image bearing member on which a developer image is formed, a developer bearing member that carries a developer and develops the image bearing member, a frame in which the developer bearing member is provided, a seal member that seals a gap between the developer bearing member and the frame such that the developer does not leak from the gap between the developer bearing member and the frame, and a sealing portion that seals a gap between the frame and the seal member such that the developer does not leak from the gap between the frame and the seal member, wherein the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and the protruding portion protrudes toward the conveyance path further than the storage portion exposed to the conveyance path.

Further features of the present invention will become apparent from the following description of exemplary embodiments (with reference to the attached drawings).

### BRIEF DESCRIPTION OF THE DRAWINGS

FIG. 1 is a partial cross-sectional view of an image forming apparatus according to an embodiment;

FIG. 2 is a schematic cross-sectional view of the image forming apparatus according to the embodiment;

FIG. 3 is a schematic cross-sectional view of a cartridge according to the embodiment;

FIG. 4 is a perspective view showing an apparatus main body with a door being opened and the cartridge;

FIG. 5 is an exploded perspective view of the cartridge according to the embodiment;

FIG. 6 is a view showing the configuration of a cleaning unit according to the embodiment;

FIG. 7 is a view showing the configuration of a developing apparatus unit according to the embodiment;

FIG. 8 is a schematic cross-sectional view showing a portion to which a seal member is attached;

FIG. 9 is a schematic partial cross-sectional view of a toner storage frame and a lid member;

FIG. 10 is a view showing a state in which elastomer according to the embodiment is injected;

FIG. 11 is a view showing a buffer portion according to the embodiment; and

FIG. 12 is a view showing the positional relationship among a sheet, a developing opening, a paper conveying rib, and the buffer portion.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

### Embodiment

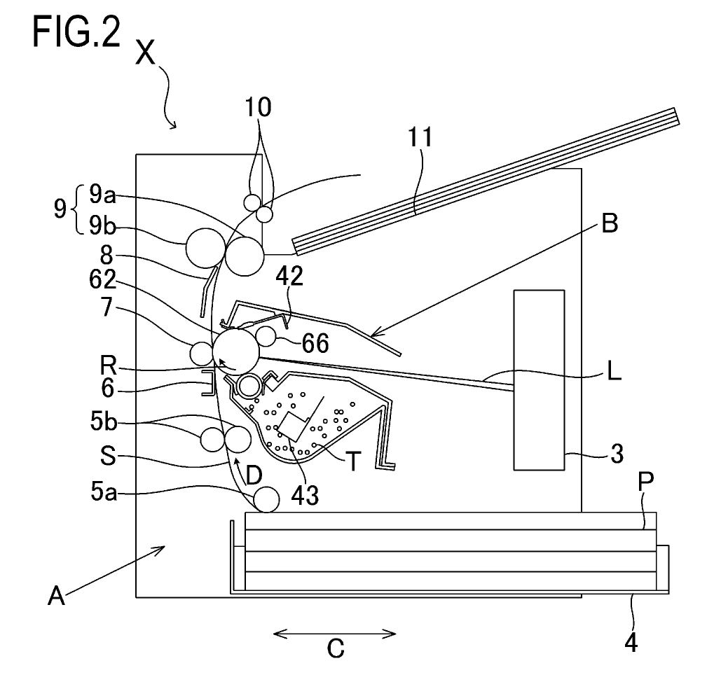

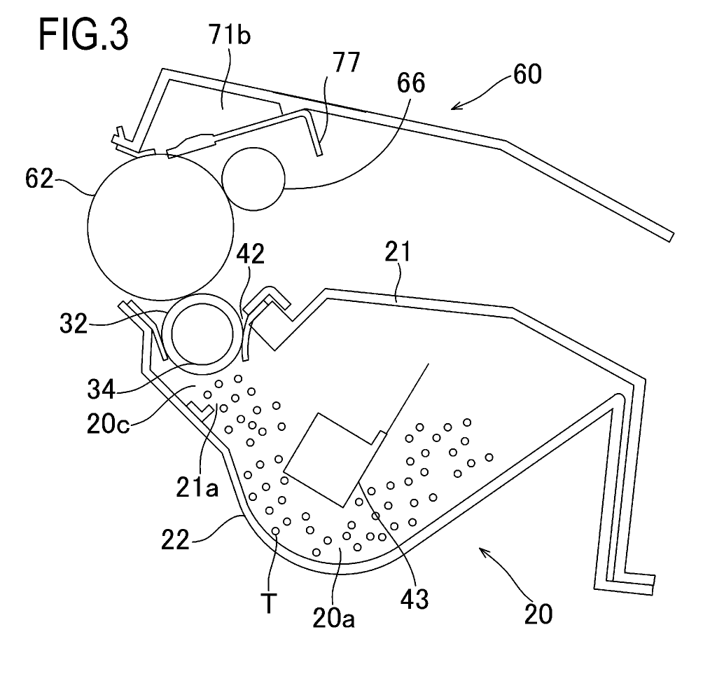

Hereinbelow, the embodiment will be described in detail by using the drawings. First, the overall configuration of an image forming apparatus X and an image forming process will be described by using FIGS. 2 and 3.

FIG. 2 is a schematic cross-sectional view of the image forming apparatus X according to the embodiment. FIG. 3 is a schematic cross-sectional view of a cartridge B as a process cartridge according to the embodiment.

Note that, in the present embodiment, the direction of the rotation center axis of an electrophotographic photosensitive drum (hereinafter referred to as a drum 62) as an image bearing member is a longitudinal direction. In addition, a direction that is orthogonal to the longitudinal direction and corresponds to the direction of an arrow C in FIG. 2 is a lateral direction. Further, in the longitudinal direction, a side on which the drum 62 receives a driving force from an apparatus main body A is a driving side, and a side opposite to the driving side is a non-driving side. The apparatus main body A is a portion obtained by removing the cartridge B from the image forming apparatus X.

<Overall Configuration of Image Forming Apparatus X>

The image forming apparatus X shown in FIG. 2 is a laser beam printer that uses electrophotographic techniques and in which the cartridge B is detachably attached to the apparatus main body A. In the image forming apparatus X, an exposure apparatus 3 (laser scanner unit) for forming an electrostatic latent image on the drum 62 in the cartridge B is disposed. In addition, below the cartridge B, a sheet tray 4 in which a sheet P as a recording medium is stored is disposed. Further, a pickup roller 5a, a conveyance roller pair 5b, a transfer guide 6, a transfer roller 7, a conveyance guide 8, a fixing apparatus 9, a discharge roller pair 10, a discharge tray 11 and the like are disposed in this order along a conveyance direction D of the sheet P in the apparatus main body A. Note that the fixing apparatus 9 is constituted by a heat roller 9a and a pressure roller 9b.

<Image Forming Process>

Next, an image forming process will be described. In the case where the image forming process is executed, first, the drum 62 is rotationally driven in a direction of an arrow R at a predetermined circumferential speed (process speed) based on a print start signal. A charging roller 66 to which a bias voltage is applied comes into contact with the outer peripheral surface of the drum 62, and uniformly charges the outer peripheral surface of the drum 62. The exposure apparatus 3 outputs a laser beam L in accordance with image information. Scanning exposure is performed on the outer peripheral surface of the drum 62 with the laser beam L. With this, the electrostatic latent image corresponding to the image information is formed on the outer peripheral surface of the drum 62.

On the other hand, as shown in FIG. 3, in a developing apparatus unit 20 as a developing apparatus, toner T as a developer in a toner storage portion 20a is stirred and conveyed by the rotation of a conveyance member 43, and is conveyed to a developing chamber 20c through a developing opening 21a. Subsequently, the toner T is carried by the surface of the developing roller 32 as a developer bearing member by the magnetic force of a magnet roller (fixed magnet). The toner T is subjected to triboelectric charging by a developing blade 42, and the layer thickness of the toner T is controlled on the outer peripheral surface of the developing roller 32. The toner T adheres to the electrostatic latent image formed on the drum 62, and the electrostatic latent image on the drum 62 is developed as a toner image that serves as a developer image.

In addition, as shown in FIG. 2, the sheet P stored in the lower portion of the apparatus main body A is sent out from the sheet tray 4 by the pickup roller 5a and the conveyance roller pair 5b at the timing of output of the laser beam L. Subsequently, the sheet P is guided by the transfer guide 6, and is conveyed to a transfer position between the drum 62 and the transfer roller 7. At the transfer position, the toner image is successively transferred to the sheet P from the drum 62.

The sheet P to which the toner image is transferred is separated from the drum 62, and is guided by the conveyance guide 8 and conveyed to the fixing apparatus 9. Subsequently, the sheet P passes through a nip portion of the heat roller 9a and the pressure roller 9b in the fixing apparatus 9. In the nip portion, the sheet P is pressurized and heated, and the toner image is thereby fixed to the sheet P. The sheet P to which the toner image is fixed is conveyed toward the discharge roller pair 10, and is discharged to the discharge tray 11 by the discharge roller pair 10.

On the other hand, as shown in FIG. 3, residual toner remaining on the drum 62 after the toner image is transferred to the sheet P is removed by a cleaning blade 77, and is reused in the image forming process. Note that the residual toner removed from the drum 62 is stored in a waste toner chamber 71b in the cleaning unit 60. Note that, in the above description, the charging roller 66, the developing roller 32, the transfer roller 7, the cleaning blade 77 and the like are process means that act on the drum 62.

<With Regard to Attachment and Detachment of Cartridge B>

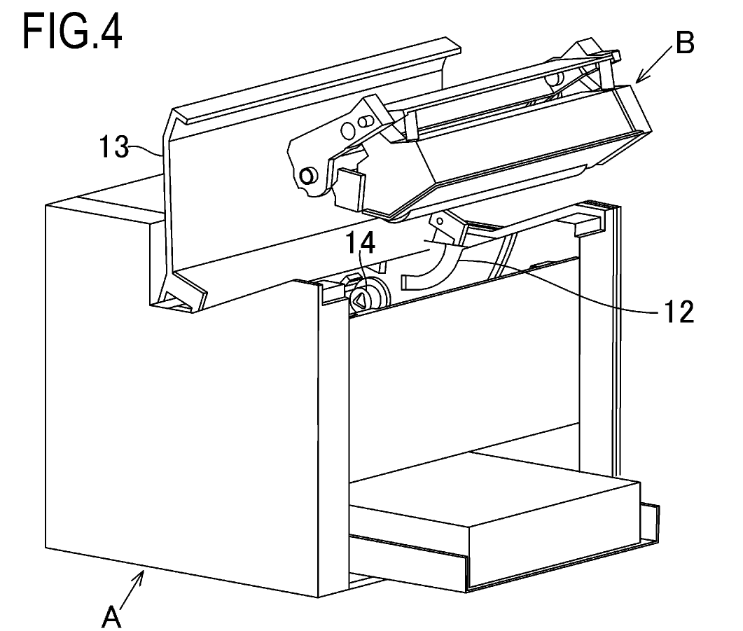

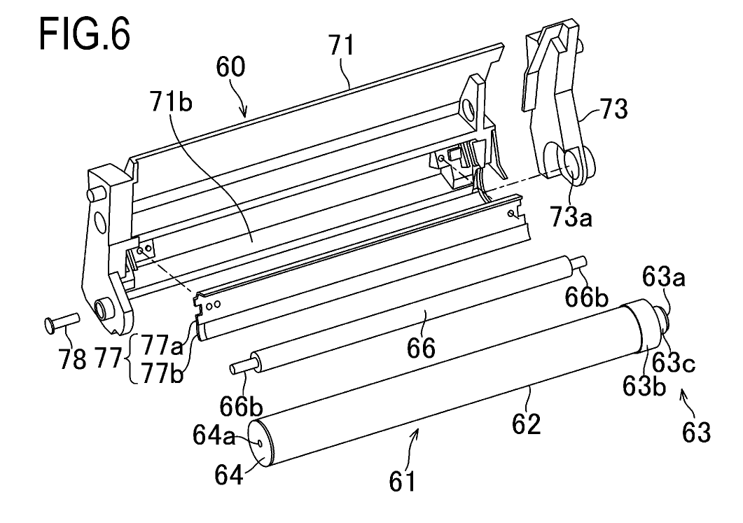

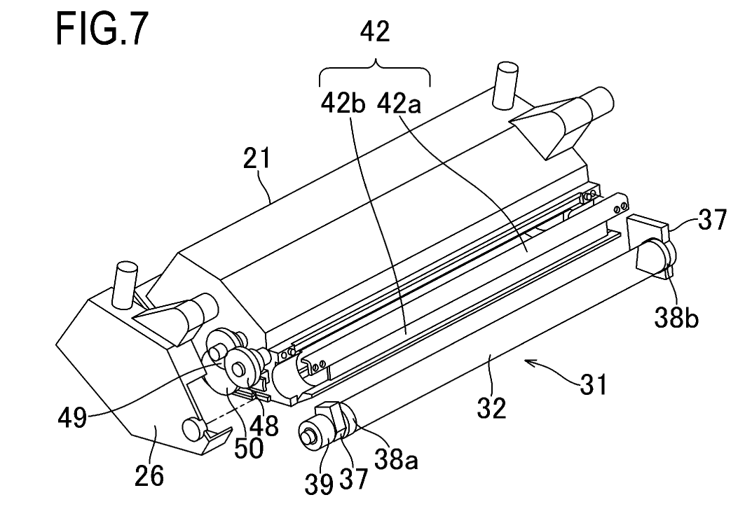

Next, attachment and detachment of the cartridge B to and from the apparatus main body A will be described by using FIG. 4. FIG. 4 is a perspective view showing the apparatus main body A with a door 13 being opened and the cartridge B. The door 13 is pivotably attached to the apparatus main body A. When the door 13 is opened, a guide rail 12 is provided, and the cartridge B is attached along the guide rail 12 in the apparatus main body A. A drive shaft 14 driven by a motor (not shown) of the apparatus main body A engages with a driving force receiving portion 63a (see FIG. 6) provided in the cartridge B. With this, the drum 62 that is coupled to the driving force receiving portion 63a receives the driving force from the apparatus main body A and rotates. Further, the charging roller 66 and the developing roller 32 (see FIG. 7) are supplied with electric power by a power supply portion (not shown) of the apparatus main body A.

<Overall Configuration of Cartridge B>

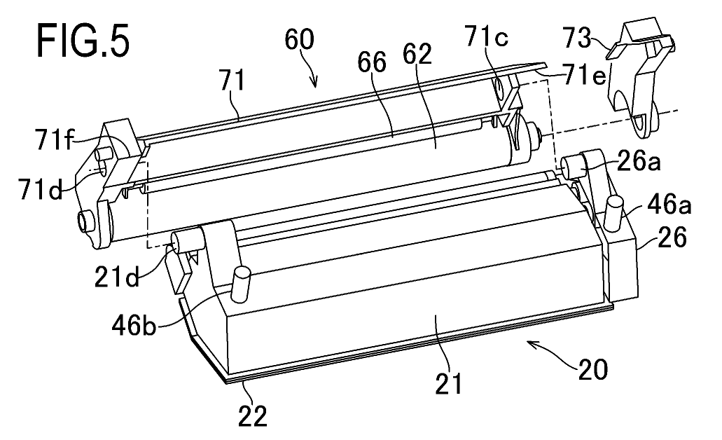

Next, the overall configuration of the cartridge B will be described by using FIGS. 5, 6, and 7. FIG. 5 is an exploded perspective view of the cartridge B according to the embodiment. FIG. 6 is a view showing the configuration of the cleaning unit 60 according to the embodiment. FIG. 7 is a view showing the configuration of the developing apparatus unit 20 according to the embodiment.

First, the configuration of the cartridge B will be described by using FIG. 5. The cartridge B is constituted by the developing apparatus unit 20 and the cleaning unit 60. The developing apparatus unit 20 is constituted by a toner storage frame 21 as a first frame, a lid member 22 as a second frame, a side member 26, the developing blade 42 (see FIG. 3), the developing roller (see FIG. 3) and the like. In the side member 26, a first supported portion 26a for rotatably supporting a cleaning frame 71 is provided on the driving side. In addition, in the toner storage frame 21, a second supported portion 21d for rotatably supporting the cleaning frame 71 is provided on the non-driving side. Herein, in the present embodiment, the toner storage frame 21 and the lid member 22 that are combined together correspond to a frame.

On the other hand, the cleaning unit 60 is constituted by the cleaning frame 71, the drum 62, the charging roller 66, the cleaning blade 77 and the like. In the cleaning frame 71, a first supporting portion 71c and a second supporting portion 71d for rotatably supporting the developing apparatus unit 20 are provided. As shown in FIG. 5, the first supported portion 26a of the side member 26 engages with the first supporting portion 71c of the cleaning frame 71, and the second supported portion 21d of the toner storage frame 21 engages with the second supporting portion 71d of the cleaning frame 71. With this, the developing apparatus unit 20 is supported rotatably relative to the cleaning unit 60.

Further, a drum bearing 73 is fixed to the cleaning frame 71, whereby the drum 62 is rotatably supported, and the developing apparatus unit 20 and the cleaning unit 60 are positioned in the longitudinal direction. In addition, in the side member 26, a biasing member 46a is provided on the driving side. In the toner storage frame 21, a biasing member 46b is provided on the non-driving side. The biasing member 46a is configured so as to abut on a spring seat 71e provided in the cleaning frame 71, and the biasing member 46b is configured so as to abut on a spring seat 71f provided in the cleaning frame 71. With this, the developing apparatus unit 20 is reliably biased in a direction toward the cleaning unit 60. In addition, as shown in FIG. 7, a distance maintaining member 38a and a distance maintaining member 38b are provided in both end portions of the developing roller 32, and they abut on the surface of the drum 62 and the distance between the developing roller 32 and the drum 62 is thereby maintained at a constant distance.

<Configuration of Cleaning Unit>

Next, the configuration of the cleaning unit 60 will be described by using FIG. 6. The cleaning blade 77 includes a supporting member 77a formed of sheet metal and an elastic member 77b formed of an elastic material such as urethane rubber, and both ends of the supporting member 77a are fixed to the cleaning frame 71 at predetermined positions using screws (not shown). The elastic member 77b abuts on the drum 62, and the residual toner is thereby removed from the outer peripheral surface of the drum 62. The removed toner is stored in the waste toner chamber 71b of the cleaning unit 60.

A shaft portion 66b of the charging roller 66 is biased in a direction toward the drum 62 and is rotatably supported by a bearing member (not shown) attached to the cleaning frame 71. The drum 62 is integrally coupled to a flange 64 and a flange 63 to thereby constitute a drum unit 61. Note that the method for coupling the drum 62 to the flanges 64 and 63 includes swaging, bonding, welding and the like.

In addition, to the flange 64, a grounding contact (not shown) or the like is coupled. Further, in the flange 63, the driving force receiving portion 63a that receives the driving force from the apparatus main body A, a gear portion 63b that transmits the driving force to the developing roller 32, and a supported portion 63c that is rotatably supported by the drum bearing 73 are provided. In the drum unit 61, the supported portion 63c is supported by a supporting portion 73a of the drum bearing 73, and the supported portion 64a of the flange 64 is rotatably supported by being supported by a drum shaft 78 that is press-fitted into the cleaning frame 71.

<With Regard to Configuration of Developing Apparatus Unit 20>

Next, the configuration of the developing apparatus unit 20 according to the present embodiment will be described. First, the schematic configuration of developing means or the like that constitutes the developing apparatus unit 20 will be described by using FIG. 7.

(Schematic Description of Developing Apparatus Unit)

The developing blade 42 is constituted by a supporting member 42a formed of sheet metal and an elastic member 42b formed of an elastic material such as urethane rubber, and both ends thereof are fixed to the toner storage frame 21 at predetermined positions using screws (not shown). In addition, the elastic member 42b abuts on the developing roller 32, whereby the amount of the toner on the outer peripheral surface of the developing roller 32 is controlled and a triboelectric charge is provided to the toner.

A developing roller unit 31 is constituted by the developing roller 32, the magnet roller 34 (see FIG. 3), the distance maintaining members 38 (the distance maintaining member 38a and the distance maintaining member 38b), bearing members 37, a developing roller gear 39 and the like. The distance maintaining members 38 are attached to both end portions of the developing roller 32. The bearing members 37 are disposed outside the distance maintaining members 38, and the developing roller gear 39 is incorporated into a portion outside the distance maintaining member 38 on the driving side. In addition, the bearing members 37 rotatably support the developing roller 32, and are fixed to the toner storage frame 21. A first gear 48 and a second gear 49 as drive transmission members are rotatably attached to the toner storage frame 21, and are configured so as not to be disconnected in the longitudinal direction by fixing the side member 26 to the toner storage frame 21. With this, the gear portion 63b (see FIG. 6), the developing roller gear 39, the first gear 48, the second gear 49, and a conveyance gear 50 connected to the conveyance member 43 mesh with each other sequentially, and the driving force received from the apparatus main body A is thereby transmitted to the developing roller 32 and the conveyance member 43 (see FIG. 3).

(With Regard to Configurations of Frame and Seal Member 47 of Developing Apparatus Unit 20)

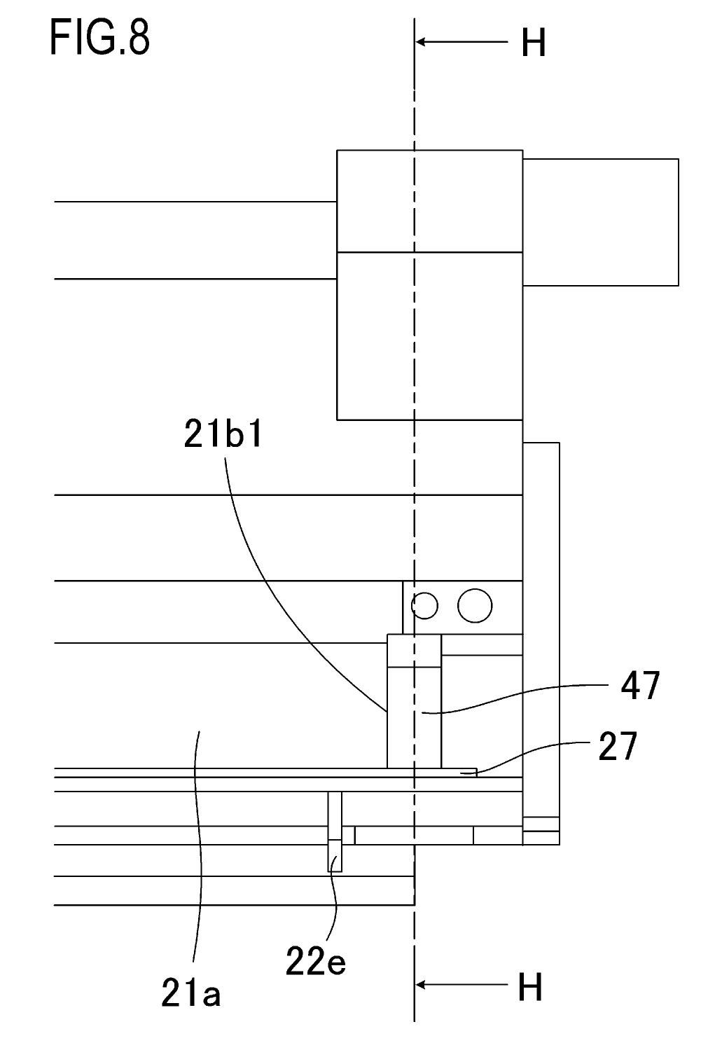

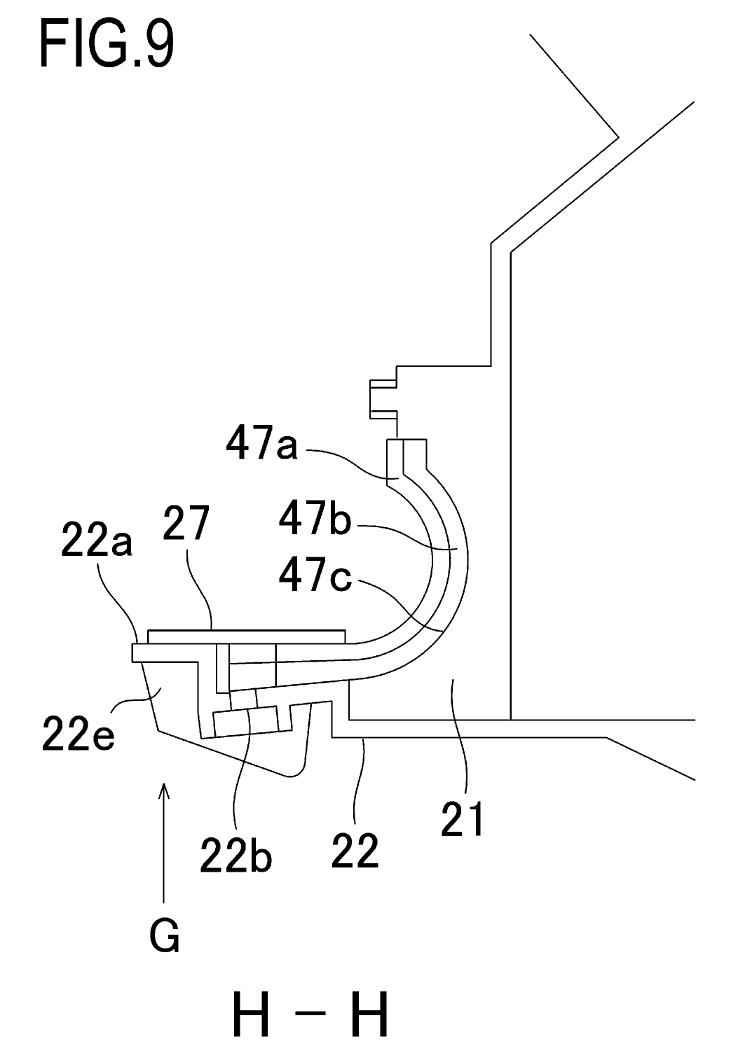

Next, the configuration of each of the toner storage frame 21, the lid member 22, and a seal member 47 according to the present embodiment will be described. First, the seal member 47 will be described by using FIGS. 8 and 9. FIG. 8 is a schematic cross-sectional view showing a portion to which the seal member 47 is attached. FIG. 9 is a cross-sectional view taken along the line H-H that intersects the longitudinal direction of each of the toner storage frame 21 and the lid member 22 in FIG. 8. Note that FIG. 8 shows only the non-driving side, but the driving side also has the same configuration.

As described above, with regard to a developing frame that constitutes the developing apparatus unit 20, by welding the toner storage frame 21 as the first frame having the developing opening 21a and the lid member 22 as the second frame together, the toner storage portion 20a and the developing chamber 20c are formed (see FIG. 3). Note that the width of the developing opening 21a in the longitudinal direction is set to the conceivable maximum width of the sheet P or more such that the toner is supplied to the sheet P as the recording medium.

As shown in FIG. 8, to an end portion 21b1 in the developing opening 21a, the seal member 47 is attached. In addition, as shown in FIG. 9, the seal member 47 is constituted by two layers of an elastic member 47b and a fiber pile 47a, and is fixed to the toner storage frame 21 using a double-sided tape 47c. The fiber pile 47a abuts on the developing roller 32, and the leakage of the toner from both end portions of the developing roller 32 is thereby prevented. On a sheet bearing surface 22a of the lid member 22, a sheet member 27 formed of PET is disposed so as to abut on the developing roller 32. With this, the leakage of the toner from the gap between the developing roller 32 and the lid member 22 is prevented over the longitudinal direction.

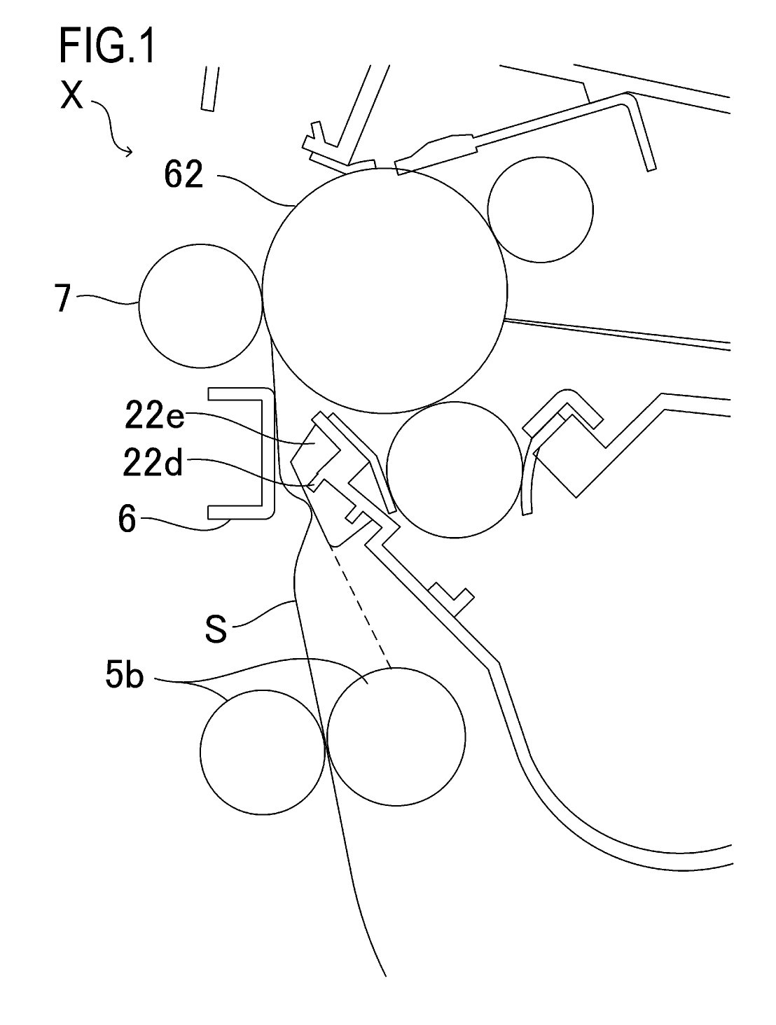

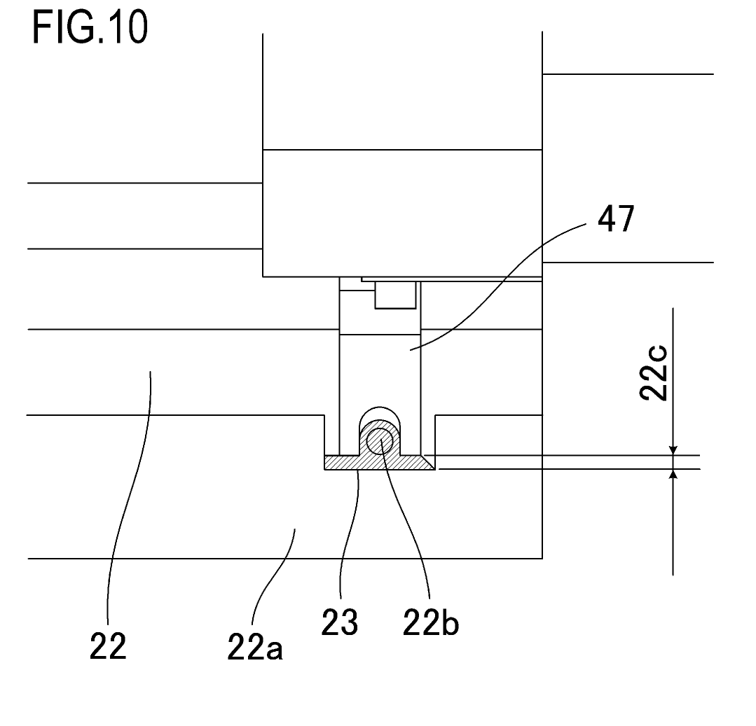

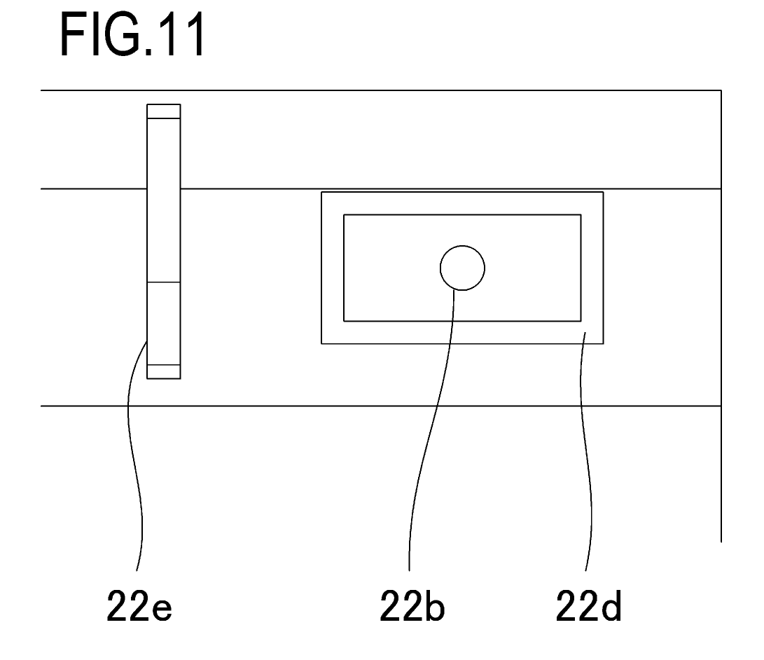

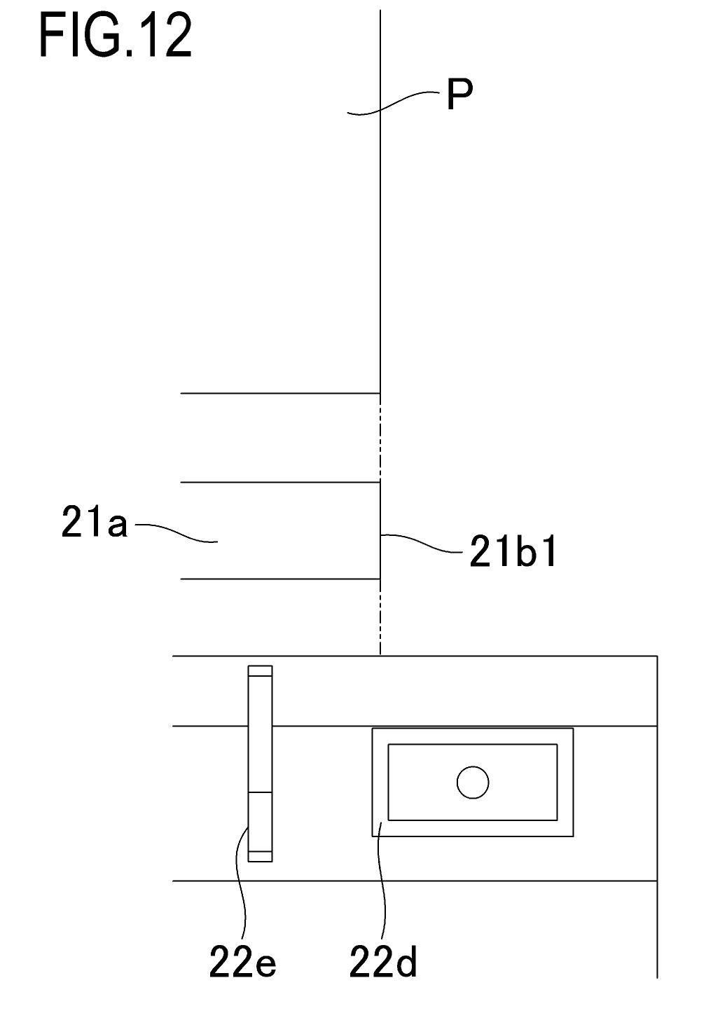

Next, elastomer as a liquid injected member and a paper conveying rib 22e as a protruding portion according to the present embodiment will be described by using FIG. 1 and FIGS. 10 to 12. FIG. 1 is a partial cross-sectional view of the image forming apparatus X in a state in which the cartridge B according to the present embodiment is inserted into the apparatus main body A. FIG. 10 is a view showing a state in which the elastomer according to the embodiment is injected. FIG. 11 is a view showing a buffer portion 22d as a storage portion according to the embodiment. FIG. 12 is a view showing the positional relationship among the sheet P, the developing opening 21a, the paper conveying rib 22e, and the buffer portion 22d.

In the present embodiment, as shown in FIG. 10, the leakage of the toner is prevented by forming a sealing portion 23 by injecting the elastomer into a gap 22c between the seal member 47 and the lid member 22 that is formed due to, for example, the part accuracy of the seal member 47 or an error at the time of assembly. Specifically, an injection portion 22b as the injection inlet of the elastomer is provided in the lid member 22, and the elastomer is injected from the back surface side (from a G direction in FIG. 9) of the surface of the lid member 22 that is in contact with the toner. The elastomer is injected after the sheet member 27 is stuck to the sheet bearing surface 22a of the lid member 22. Subsequently, as shown in FIG. 11, the buffer portion 22d is provided around the injection portion 22b such that the elastomer that becomes redundant due to variations in the size of space in which the sealing portion 23 is formed does not jut out from the contour of the lid member 22. In the present embodiment, the buffer portion 22d is configured so as to be formed into a substantially rectangular shape to surround the injection portion 22b using a rib. In addition, as shown in FIG. 1, the buffer portion 22d is exposed to a paper path S as a conveyance path in which the sheet P is conveyed, and protrudes toward the paper path S. In the present embodiment, since the buffer portion 22d surrounds the injection portion 22b, even when the elastomer spills out of the injection portion 22b to the side of the buffer portion 22d, it is possible to prevent the elastomer having spilled out from jutting out from the contour of the developing apparatus unit 20. In addition, with the buffer portion 22d that surrounds the injection portion 22b, the elastomer having spilled out adheres to the inner wall of the buffer portion 22d, and hence it is possible to prevent the elastomer from jutting out from the contour of the developing apparatus unit 20.

In addition, in the present embodiment, as shown in FIG. 12, the paper conveying rib 22e is provided inwardly of the buffer portion 22d in the longitudinal direction on the back surface of the lid member 22, similarly to the buffer portion 22d. Specifically, the paper conveying rib 22e protrudes toward the paper path S further than the buffer portion 22d such that the sheet P does not come into contact with the buffer portion 22d. In addition, the paper conveying rib 22e is provided at a position that prevents the sheet P from coming into contact with the buffer portion 22d. The paper conveying rib 22e is provided inwardly of the end portion 21b1 of the developing opening 21a in the longitudinal direction. That is, the paper conveying rib 22e overlaps the sheet P as viewed from the direction of protrusion of the paper conveying rib 22e when the sheet P passes through the paper conveying rib 22e. Further, as shown in FIG. 1, the paper conveying rib 22e is inclined so as to approach the paper path S with approach to the downstream side in the direction in which the sheet P is conveyed. Note that, in the present embodiment, the paper conveying rib 22e has a shape that extends along the conveyance direction of the sheet P, and also plays a role in guiding the sheet P toward the direction in which the sheet P is to be conveyed. Note that, in the present embodiment, one of the two paper conveying ribs 22e and the other of the two paper conveying ribs 22e are disposed between the two buffer portions 22d in the direction of the rotation center axis of the developing roller 32. In addition, in the present embodiment, the buffer portion 22d is provided in the vicinity of each of both ends of the developing roller 32 in the direction of the rotation center axis of the developing roller 32. Further, the paper conveying rib 22e is also provided in the vicinity of each of the both ends of the developing roller 32 in the direction of the rotation center axis of the developing roller 32.

As shown in FIG. 1, in the present embodiment, in the case where the curled sheet P is conveyed not to the side of the transfer guide 6 but to the side of the buffer portion 22d after passing through the conveyance roller pair 5b, the paper conveying rib 22e guides the sheet P to the side of the transfer guide 6. That is, according to the present embodiment, by providing the paper conveying rib 22e, it is possible to prevent the sheet P from colliding with the buffer portion 22d to cause jamming even in the case where the sheet P is curled.

Thus, in the present embodiment, the paper conveying rib 22e protrudes toward the paper path S further than the buffer portion 22d such that the sheet P does not come into contact with the buffer portion 22d. With this, in the case where the buffer portion 22d is exposed to the path of the sheet P, it is possible to prevent the sheet P from coming into contact with the buffer portion 22d to thereby cause the jamming.

In addition, in the present embodiment, the paper conveying rib 22e is capable of guiding the sheet P toward the direction in which the sheet P is to be conveyed.

Further, in the present embodiment, the paper conveying rib 22e approaches the paper path S as the paper conveying rib 22e extends in the conveyance direction of the sheet P. With this, it is possible to guide the sheet P toward the direction in which the sheet P is to be conveyed.

In addition, in the present embodiment, the paper conveying rib 22e is formed by extending part of the buffer portion 22d toward the paper path S. Part of the buffer portion 22d serves as the paper conveying rib 22e, whereby it is possible to save a material for forming the paper conveying rib 22e.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-118005, filed Jun. 14, 2016, which is hereby incorporated by reference herein in its entirety.

What is claimed is:

1. A developing apparatus forming a developer image with a developer, comprising:
a developer bearing member that carries the developer;
a frame in which the developer bearing member is provided;
a seal member that seals a gap between the developer bearing member and the frame such that the developer does not leak from the gap between the developer bearing member and the frame; and
a sealing portion that seals a gap between the frame and the seal member such that the developer does not leak from the gap between the frame and the seal member, wherein
the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and
the protruding portion protrudes toward the conveyance path further than the storage portion exposed to the conveyance path.

2. The developing apparatus according to claim 1, wherein the protruding portion is provided at a position that prevents the recording medium from coming into contact with the storage portion.

3. The developing apparatus according to claim 1, wherein
the protruding portion guides the recording medium toward a direction in which the recording medium is to be conveyed.

4. The developing apparatus according to claim 1, wherein
the protruding portion approaches the conveyance path of the recording medium as the protruding portion extends in a conveyance direction of the recording medium.

5. The developing apparatus according to claim 1, wherein
the protruding portion overlaps the recording medium as viewed from a direction of protrusion of the protruding portion when the recording medium passes through the protruding portion.

6. The developing apparatus according to claim 1, wherein
the developer bearing member is a developing roller,
the storage portion is provided in a vicinity of each of both ends of the developer bearing member in a direction of a rotation center axis of the developer bearing member, and
the protruding portion is also provided in the vicinity of each of the both ends of the developer bearing member in the direction of the rotation center axis of the developer bearing member.

7. The developing apparatus according to claim 6, wherein
one of the protruding portions and the other of the protruding portions are disposed between one of the storage portions and the other of the storage portions in the direction of the rotation center axis of the developer bearing member.

8. The developing apparatus according to claim 1, wherein
the protruding portion is formed by extending part of the storage portion toward the conveyance path.

9. A process cartridge detachably attached to an apparatus main body of an image forming apparatus, the process cartridge comprising:
an image bearing member on which a developer image is formed;
a developer bearing member that carries a developer and develops the image bearing member;
a frame in which the developer bearing member is provided;
a seal member that seals a gap between the developer bearing member and the frame such that the developer does not leak from the gap between the developer bearing member and the frame; and
a sealing portion that seals a gap between the frame and the seal member such that the developer does not leak from the gap between the frame and the seal member, wherein
the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and
the protruding portion protrudes toward the conveyance path further than the storage portion exposed to the conveyance path.

10. The process cartridge according to claim 9, wherein
the protruding portion is provided at a position that prevents the recording medium from coming into contact with the storage portion.

11. The process cartridge according to claim 9, wherein
the protruding portion guides the recording medium toward a direction in which the recording medium is to be conveyed.

12. The process cartridge according to claim 9, wherein
the protruding portion approaches the conveyance path of the recording medium as the protruding portion extends in a conveyance direction of the recording medium.

13. The process cartridge according to claim 9, wherein
the protruding portion overlaps the recording medium as viewed from a direction of protrusion of the protruding portion when the recording medium passes through the protruding portion.

14. The process cartridge according to claim 9, wherein
the developer bearing member is a developing roller,
the storage portion is provided in a vicinity of each of both ends of the developer bearing member in a direction of a rotation center axis of the developer bearing member, and
the protruding portion is also provided in the vicinity of each of the both ends of the developer bearing member in the direction of the rotation center axis of the developer bearing member.

15. The process cartridge according to claim 14, wherein
one of the protruding portions and the other of the protruding portions are disposed between one of the storage portions and the other of the storage portions in the direction of the rotation center axis of the developer bearing member.

16. The process cartridge according to claim 9, wherein
the protruding portion is formed by extending part of the storage portion toward the conveyance path.

17. An image forming apparatus comprising:
an image bearing member on which a developer image is formed;
a developer bearing member that carries a developer and develops the image bearing member;
a frame in which the developer bearing member is provided;
a seal member that seals a gap between the developer bearing member and the frame such that the developer does not leak from the gap between the developer bearing member and the frame; and
a sealing portion that seals a gap between the frame and the seal member such that the developer does not leak from the gap between the frame and the seal member, wherein
the frame is provided with an injection inlet for injecting elastomer for forming the sealing portion, a storage portion in which the elastomer spilling out of space in which the sealing portion is formed is stored, and a protruding portion that protrudes toward a conveyance path of a recording medium to which the developer image is transferred, and
the protruding portion protrudes toward the conveyance path further than the storage portion exposed to the conveyance path.
